(19) United States
(12) Patent Application Publication
(10) Pub. No.: US 2009/0143052 A1
(43) Pub. Date: Jun. 4, 2009

(54) SYSTEMS AND METHODS FOR PERSONAL INFORMATION MANAGEMENT AND CONTACT PICTURE SYNCHRONIZATION AND DISTRIBUTION

(76) Inventors: Michael Bates, Paradise Valley, AZ (US); James Ferguson, Tempe, AZ (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 12/326,075

(22) Filed: Dec. 1, 2008

Related U.S. Application Data
(60) Provisional application No. 61/052,975, filed on May 13, 2008.
(60) Provisional application No. 60/991,030, filed on Nov. 29, 2007.

(51) Int. Cl. H04M 3/42; G06F 17/30; G06F 15/16; G06F 3/048

(52) U.S. Cl. 455/414.2; 707/100; 707/104.1; 707/3; 709/231; 715/810; 707/E17.044; 707/E17.005; 707/E17.019; 707/E17.014

(57) ABSTRACT

Systems and methods for facilitating contact information display, management and synchronization are described. A client application on a portable device in communication with a host system provides a mechanism for receiving, displaying, updating, processing and transmitting contact information and data to the host system, where it may then be synchronized with other devices associated with other users. The host system may also collect information from social networking sites and other locations to update and synchronize contact information and data.

### CROSS-REFERENCE TO RELATED APPLICATIONS

This application claims priority under 35 U.S.C. § 119(e) to U.S. Provisional Patent Application Ser. No. 61/052,975, entitled SYSTEMS AND METHODS FOR PERSONAL INFORMATION MANAGEMENT AND CONTACT PICTURE SYNCHRONIZATION AND DISTRIBUTION, filed on May 13, 2008 and to U.S. Provisional Patent Application Ser. No. 60/991,030, entitled SYSTEMS AND METHODS FOR PERSONAL INFORMATION MANAGEMENT AND CONTACT PICTURE SYNCHRONIZATION AND DISTRIBUTION, filed on Nov. 29, 2007. This application is also related to U.S. Utility patent application Ser. No. 12/024,894, entitled ANONYMITY ENGINE FOR ONLINE ADVERTISING, SALES AND INFORMATION DISTRIBUTION, filed Feb. 1, 2008 and to U.S. Utility patent application Ser. No. 11/940,257, entitled SYSTEMS AND METHODS FOR ONLINE ADVERTISING, SALES, AND INFORMATION DISTRIBUTION, filed Mar. 14, 2007. The content of each of these applications is hereby incorporated by reference herein in its entirety for all purposes.

### FIELD OF THE INVENTION

The present invention relates generally to the synchronization and distribution of data related to Personal Information Management, such as updating the information contained in the address book or contacts list on a cell phone or other portable device. More particularly but not exclusively, the present invention relates to systems and methods for adding and updating personal information in personal management systems, both online and contained within mobile devices.

### BACKGROUND

A range of online services, desktop applications and mobile devices currently exist which contain personal information for contacts, such as phone number and email. Additionally, many Internet social networking and other online sites now contain personal information. Commonly known examples include providers such as MySpace and Facebook, though there are many others. Many people do not have the time or resources required to keep their Personal Information Management (address book and contact information) systems up to date, and in particular many do not have picture, video and audio information pertaining to these contacts.

At the same time, there has been a proliferation of cell phones and other handheld devices incorporating digital cameras and other media capture devices and display devices that allow for faster capture and download of information such as text, photographs, video clips, or other media. This means the capability readily exists for users to create personal media information such as pictures and video. Accordingly, there is a need in the art for new systems and methods for capturing, organizing, updating and displaying such personal and contact information, along with associated data.

### SUMMARY

The present invention relates generally to systems and methods for personal information management and contact picture synchronization and distribution.

In one aspect, the present invention is related to a host system for managing contact information, comprising a network interface for coupling the host system to the Internet and to one or more telephony communication networks, a database, and a server configured to: communicate with a first portable device of a plurality of portable devices through the network interface to receive a set of contact information for a first user associated with the first portable device, store, in the database, said contact information for said first user, and transmit said contact information for said first user to a second portable device of said plurality of portable devices for synchronization with a set of contact data stored on said second portable device.

In another aspect, the present invention is related to a host system for managing contact information, comprising a network interface for coupling the host system to the Internet and to one or more telephony communication networks, a database, and a server configured to: communicate with a first portable device of a plurality of portable devices through the network interface to receive a set of contact information for a first user associated with the first portable device, store, in the database, said contact information for said first user, update a contact record for a contact of said first user stored in the database, and transmit said updated contact record to said first device for synchronization with the corresponding contact information on the first device.

In yet another aspect, the present invention is related to a method for managing contact information, comprising receiving at a host system, from a first portable device in communication with the host system, a set of contact information for a first user associated with the first portable device, storing, in a database, said contact information for said first user, and transmitting said contact information for said first user to a second portable device for synchronization with a set of contact data stored on said second portable device.

In yet another aspect, the present invention is related to a method of facilitating contact synchronization between two or more portable devices, comprising retrieving a set of contact information stored on a first portable device, generating a synchronization file including the set of contact information, and transmitting the synchronization file to a second portable device, wherein the synchronization information is used by a client application on the second device to update a contact record on the second device.

In yet another aspect, the present invention is related to a method of facilitating contact backup with a portable device, comprising retrieving a set of contact information stored on said portable device, generating a synchronization file including the set of contact information, and transmitting the synchronization file to a host system, wherein the contact information is stored in a database of said host system.

In yet another aspect, the present invention is related to a method for providing contact location information, comprising receiving from a portable device at a host system location information for a first user, selecting a second device associated with a second user to receive said location information, and sending said location information from said host system to said second device.

In yet another aspect, the present invention is related to a method for presenting contact information on a portable device, comprising receiving, from a host system, a contact record for a first contact of a plurality of contacts associated with a user of the portable device, storing said contact record in a memory of said portable device, and displaying one or more items of data comprising said contact record on a display of said portable device in response to a first device action.

In yet another aspect, the present invention is related to a method for presenting contact information on a portable device comprising retrieving, from a memory in said portable device, ones of a plurality of images associated with a corresponding plurality of contacts, displaying, on a grid presented on a display of said portable device, said plurality of images, receiving, response to a user actuation, a device input associated with one of said plurality of images, and initiating, responsive to said receiving, a function on said portable device.

In yet another aspect, the present invention is related to a method of screening contacts on a portable device, comprising receiving, at a host system, incoming call information from a portable device associated with a first user, comparing said incoming contact information to ones of a plurality of records defining potentially threatening callers associated with said call information stored in a database of said host system, and blocking, responsive to said comparing, connection of said incoming call to said portable device.

In yet another aspect, the present invention is related to a method for facilitating large file transfers between two or more portable devices, comprising receiving, from a first portable device, a request to send a file to a second user, wherein said request is responsive to a limitation in file transfer capabilities associated with a telecommunication service provided to said first device, initiating, responsive to said request, a data stream with said first device, wherein said data stream comprises said file, storing, in a memory, said file, and initiating, with a second device, a second data stream, wherein said second data stream comprises said file.

In yet another aspect, the present invention is related to a method of providing contact information between portable devices, comprising receiving, from a first portable device associated with a first user, a request to send contact information to a second user, wherein said second user is associated with a second portable device, providing an interface to said first user, said interface including one or more options for selection of ones of a plurality of banner ads, receiving, from said first user, a selection of one or more of said plurality of banner ads, selecting an image associated with the first user, and transmitting the image and the one or more selected banner ad to the second device.

In yet another aspect, the present invention is related to a method of providing anonymous communications, comprising receiving at a host system, from a first user, a request to communicate with a second user based on a username of said second user, determining, based on a first username associated with the first user and the second username, contact information for said first user and said second user, and providing a bridged connection between said first user and said second user.

In yet another aspect, the present invention is related to a method for displaying contact information on a portable device, comprising storing, in a memory of said portable device, contact information for a plurality of contacts associated with a first user of the portable device, formatting said contact information for said plurality of contacts in a matrixed configuration, and displaying said matrixed configuration on a display of said portable device, wherein said contacts are connected in said matrix based on a contact relationship with said first user.

Additional aspects of the present invention are described below with respect to the appended drawings.

### BRIEF DESCRIPTION OF THE DRAWINGS

For a better understanding of the nature and objects of various embodiments of the invention, reference should be made to the following detailed description taken in conjunction with the accompanying drawings, wherein:

FIG. 1 illustrates an example system on which may be implemented various embodiments of the present invention;

FIG. 2 illustrates a device configuration for a portable device on which may be implemented various embodiments of the present invention;

FIG. 3 illustrates a host system configuration on which may be implemented various embodiments of the present invention;

FIG. 4 illustrates an embodiment of a portable device and client application user interface and display in accordance with aspects of the present invention;

FIG. 5 illustrates an embodiment of a portable device and client application user interface and display in accordance with aspects of the present invention;

FIG. 6 illustrates a system configuration on which may be implemented embodiments of the present invention;

FIG. 7 illustrates an embodiment of a portable device and client application user interface for an incoming contact call, in accordance with aspects of the present invention;

FIG. 8 illustrates an embodiment of a portable device and client application user interface for contact information display and selection in accordance with aspects of the present invention;

FIG. 9 illustrates an embodiment of a portable device and client application user interface for contact information display and option selection in accordance with aspects of the present invention.

### DETAILED DESCRIPTION OF EMBODIMENTS OF THE PRESENT INVENTION

The present invention relates generally to systems and methods for personal information management and contact picture synchronization and distribution. In particular, various embodiments of the present invention are directed to processing steps and associated systems and applications for adding and updating personal information, including picture, video and audio information in Personal Information Management (PIM) systems, both online and contained within portable devices. Various embodiments may allow a user to update their information and have this information automatically disseminated to their portable devices as well as to other users and their devices. In addition, contact information synchronization may be implemented in conjunction with a host processing system. As used herein, the term “contact information” generally includes specific textual information regarding a particular contact or “friend” of a user, such as their name, address, phone numbers, email or other identifying data. In addition, contact information may also include other data such as image files (such as jpg or other format pictures or images), audio files (such as wav, mp3 or other audio files), video clips (such as mpeg, avi or other video files) or other types of media content that is associated with the contact/friend.

In a typical embodiment, a host processing system (also denoted herein as a “host system” for brevity) includes one or more servers (also denoted herein as “host servers” or “IQZone servers”) configured to collect user information from a myriad of sources, including online social networking sites, and store this information in one or more databases in or associated with the host processing system. The host system may also be configured to interact with the users' portable devices to facilitate contact information updating and synchronization.

In addition, the host processing system may be configured to allow users to update, edit and add to their information and exchange information with other users. Users' portable and mobile devices may be configured in conjunction with a client application to facilitate the display of media content, such as by displaying a picture of the calling party, based on the caller ID, for a device action such as an incoming call. In addition, various embodiments allows synergy between the ability to create the media and display the media in the appropriate personal content, such as on incoming calls, while allowing users to easily acquire personal data, such as picture content, and synchronize it with their Personal Information Management systems.

In an exemplary embodiment, a user is provided with an application program (also denoted herein as a “client application”) that may be installed on the user's portable device to facilitate downloading of media content and updating of their PIM system in conjunction with the host processing system. The user may create their own personal content and push it out directly to other users and their mobile devices and PIM systems. The host processing system may be configured to read a user's current contacts, synchronize and update contact information as needed, and then send the application out to the devices, along with personally created user information such as an updated contact picture, video, audio clip or other identifying information.

As such, various embodiments of the present invention create a centralized database of contact information in or in conjunction with the host processing system, which may be updated from users, their cell phones, PDAs or other portable or mobile devices, and/or Internet sites. The information may include a variety of data and information including contact information, pictures, ringtone information, audio and/or video clips, and/or other information and data. This information is then automatically disseminated, according to a set of user and host system rules, to appropriate destinations, including the user's phone, other users' phones and/or Internet sites.

By way of example, a user may submit a new picture (i.e., a digital photographic image or other type of image) and status message, via a variety of methods as are further described herein, to the host system and have that information automatically transferred to their friends' phones as their caller ID picture, and also have their social networking sites, such as FaceBook and MySpace, automatically updated with the new picture and status. In some embodiments, this may also be done by direct communication between a client running on a first user's portable device and a client running on a second user's portable device. As another example, a user may update their picture and status on a social networking site such as MySpace® or Facebook® and then have this information automatically updated on all of their friends' phones or other portable devices.

The systems and methods disclosed herein are applicable to a wide range of applications related to input, display, storage, processing, transmission, delivery, and other aspects of (PIM) systems. For purposes of explanation, the following description is provided with reference to specific nomenclature and implementation details, typically in the context or a portable device in the form of a cellular or mobile phone; however, it will be apparent to one skilled in the art that specific details described are not required in order to practice the invention, and that other embodiments in keeping within the spirit and scope of the present invention are possible and fully contemplated herein.

Content Sources and Content Selection and Provision

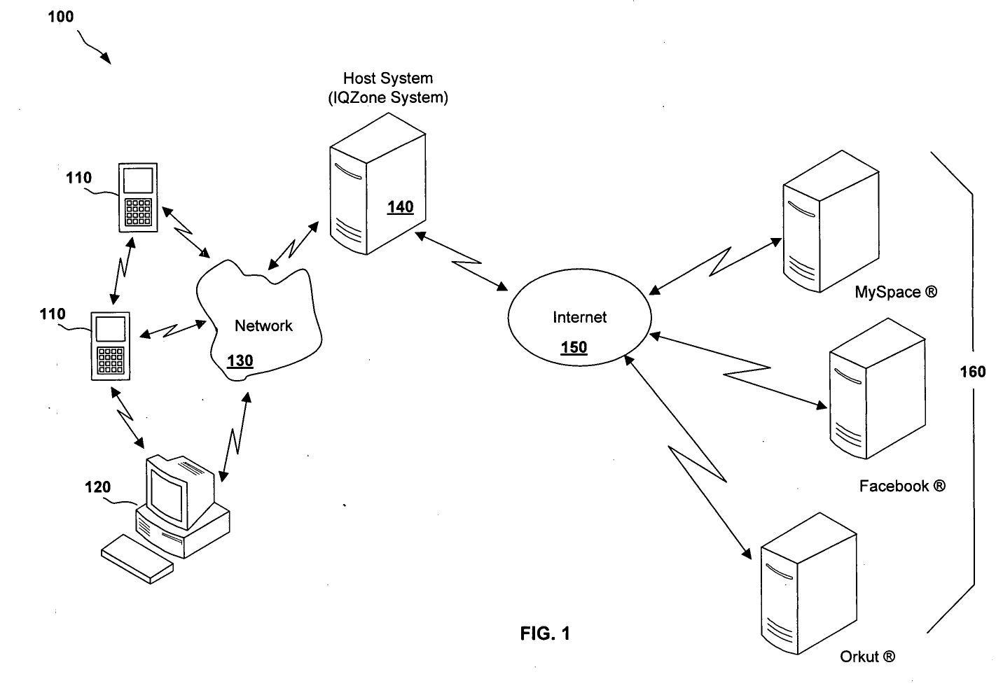

According to certain aspects of the present invention, user supplied information may be provided to various embodiments of the present invention for storage, analysis, processing, display, transmission and/or other purposes. Attention is now directed to FIG. 1, which illustrates a system 100 on which may be implemented embodiments of the present invention. As shown in FIG. 1, content may originate from sources such as social networking sites 160 such as MySpace®, Facebook® or any of many other sites that contain picture/image information, email information, phone number information and/or other use data or information. In addition to those shown in FIG. 1, it will be apparent to one of ordinary skill in the art that other sources of content are available and other means, in addition to the Internet and Cellular/Telephony networks, may be employed to provide such content. Accordingly, the above list of content sources is only intended to be representative, not limiting.

Communications Between Devices and Systems

System 100 includes one or more portable or mobile devices 110 (also denoted herein for brevity as “devices 110”) such as cellular phones, PDAs, Wi-Fi (802.11) devices or other portable devices. It is further noted that, in some embodiments, the portable device need not necessarily be portable and the functionality herein may be implemented on more stationary devices such as desktop or notebook computers or other types of fixed devices. In addition, portable devices as described herein may include other types of devices that are mobile but not necessarily portable.

In addition to devices 110, system 100 may include one or more computers 120 such as desktop computers, portable or notebook computers or other devices or systems incorporating computer functionality along with wired or wireless network connectivity. For example, embodiments of the present invention may be implemented on various types of embedded devices or Internet appliance devices or similar types of devices.

System 100 further includes a host processing system 140 (also denoted herein as “host system 140”) comprising one or more servers as well as other associated computer and data processing hardware (not shown in FIG. 1) such as networking equipment, displays, monitors, I/O devices or other computer or data communication systems, hardware and/or software. In an exemplary embodiment, host system 140 (also denoted herein as “IQZone system 140” based on a system provided by a particular services supplier) may be provided by or operated by an associated host services company or host services supplier.

In one or more embodiments, the host service company may be a company known as IQZone Inc., which offers an associated host service (also denoted herein as the “IQZone service”) at the web site www.iqzone.com. In addition, functionality as described herein may be provided in the form of services denoted as FaceDial™, PicDial ™, PictureDial™, or by other names or service marks owned by IQZone Inc. or other host service providers. Some display and interface embodiments shown in the appended drawings are illustrated as being part of a FaceDial™ or PicDial™ services provided by IQZone Inc.

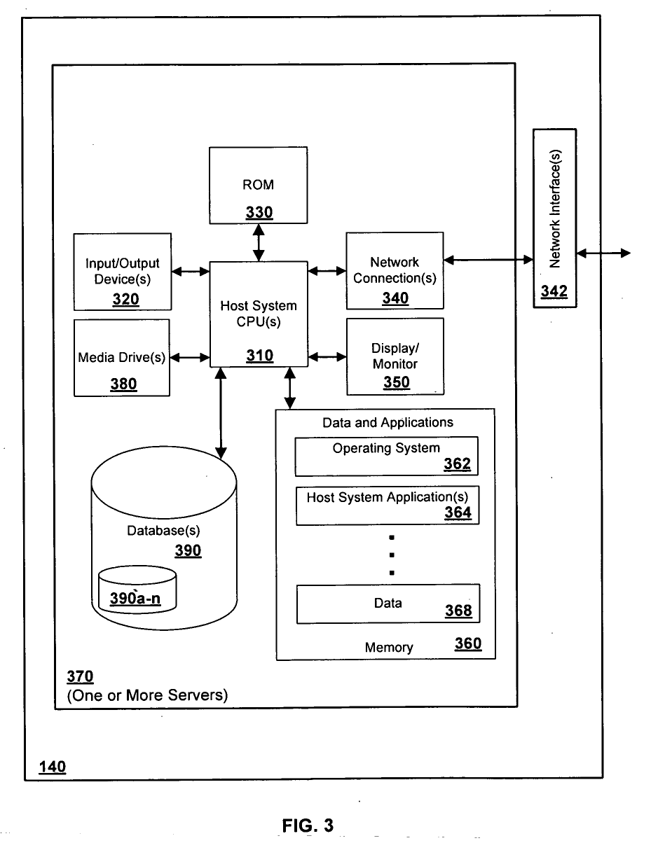

As noted previously, host system 140 includes one or more servers that include one or more databases 390 (as shown in FIG. 3) either internal or external to the servers 370. These databases may be used to store user information and data such as is further described below. Host system 140 may also include one or more operating systems 362 associated with the servers, as well as one or more application programs to implement the various host service functionality as is described further herein. Host system 140 may be implemented at a centralized physical location such as a network connected server farm or other similar facility and/or may comprise a plurality of distributed servers connected by any of a variety of networking connections at different physical locations.

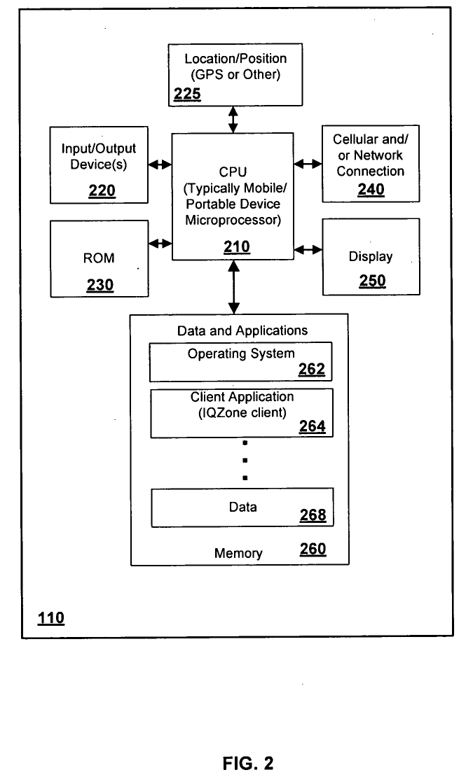

Devices 110 and computers 120 (also denoted collectively herein as devices 110 and 120 for brevity) are typically configured to connect to each other and/or to host system 140 through network 130 as shown in FIG. 1. Network 130 may include wired or wireless networking elements such as Ethernet, LAN technologies, telephony networks such as POTS phone networks, cellular networks, data networks, or other telephony networks as well as Wi-Fi or Wi-Max networks, other wired or wireless Internet network connections and/or other networks as are known or developed in the art. These connections may be facilitated by one or more client applications 264 (as shown in FIG. 2) running on devices 110 or 120 as well as one or more host system applications 364 running on one or more host system servers 370 (also denoted herein as IQZone servers) included in host system 140, along with one more network interfaces 342 and/or other networking hardware and/or software as is known or developed in the art (not shown).

Host system 140 is further configured to provide a network connection through the Internet to one or more social networking sites 160, such as sites offered by MySpace®), Facebook®), Orkut®), and/or other social networking or equivalent or similar sites. These connections may be facilitated by one or more application programs 364 running on host system 140.

For example, as shown in FIG. 1, data may be transferred to or from one portable device 110 directly to another portable device 110 in conjunction with client applications 264. Data can be transferred using any communication mechanism supported by both devices. For example, a data connection using standard telephony connections as well as sockets, a Bluetooth connection, an infrared connection, a serial connection or a USB connection may be used. As well as, or in addition, data may be transferred to or from a device 110 to a computer system 120. For example, a user may wish to transfer a video clip such as a personal user video, vacation video, or other type of video to another user's phone. To do this, a connection is made with client applications 264 running on each phone. The connection can be any connection that is supported by both devices that the client application can control and that can transmit data. Once a successful connection is made, the data is streamed from one device to the other. Both client applications 264 check for errors, and if successful, they report that a successful transfer has completed.

In addition, devices 110 and/or 120 are configured to communicate with the host system 140 (i.e., IQZone system and associated IQZone server or servers 370). This communication may be done using a variety of methods as are known or developed in the art including pull, push, incremental, full-updates and/or other methods.

By way of example, in one embodiment a “pull” method, as is known in the art, may be used. In this embodiment, data is requested by device 110 or 120 from the host system 140 and is then pulled from the host system 140. For example, when device 110 is a cell phone, when the cell phone first synchronizes its address book, as well as, in some embodiments, during subsequent synchronization events, the client application 264 will create a synchronization file containing contact information for contacts stored on the portable device 110, which is then sent to the host system 140 for storage in database 390. This synchronization file may contain available information and data in the address book, such as name, phone number(s), addresses, notes or other data or information associated with the contacts, such as images, video clips audio files, and/or other information. In one embodiment, a set of contact information/data associated with ones of a plurality of contacts of the device user are stored in a contact record, where each contact record includes the corresponding contact information such as the contact's name, address, phone numbers, email addresses, images, video or audio clips, and/or other contact information. The specific contact data may be stored in a set of contact fields for each contact to facilitate contact information storage and retrieval.

The client application 264 then performs an iteration through every accessible contact field in the address book and the name of the field is recorded, along with the associated data. The client application then prepares the field names and data to be sent to the host system 140. In an exemplary embodiment, the data is sent in XML format, which may be formatted as: <email>username@host.com/email.

The synchronization file is then sent to the host system 140 (i.e., IQZone system and associated server(s) 370) where it is processed and corresponding updated information may be pulled back to the originating device 110 and/or to other devices 110. The data may be stored in a database in host system 140, such as database 390, as name and value pairs, or in other database formats and fields. For instance, email data may be stored in the following format: “EMAIL”, jamesferguson@iqzone.com, for a contact named James Ferguson with the email address jamesferguson@iqzone.com. When a device 110 is pending receipt of data, a check is made by host system 140 to determine which field names the device 110 supports. In a typical embodiment, after this check is done by host system 140, only the fields that the device 110 supports are sent. For example, if the device does not support an “Anniversary” field, but that field is stored in the database 390 for a particular contact, the field will be ignored and not sent to the device 110.

In a similar fashion, updated user information for a particular contact and may be synchronized with and transmitted to other users or contacts by host system 140. For example, when a first user updates his or her information in this fashion, their updated information may be sent by host system 140 to all of the first user's contacts on the contacts' associated devices 110. Similarly, host system 140 may poll or otherwise periodically check the contact information and status for various users of the host system 140, update their information in the database 390, and/or transmit that updated information to other user's that may be contacts or otherwise have a connection with the polled user.

User Information Updating

In various embodiments, a user can update their personal information, such as caller ID, photo, status message and/or other contact information in a variety of ways. For example, a user may be provided with a user account and user specific web page at the host system 140 that is associated with a host service. In an exemplary embodiment, this service is provided by IQZone Inc. Once the user account is created, the user may then access a computer based (i.e., a web page accessible from a desktop or notebook computer web browser) or mobile web site (i.e., a web page accessible from a portable device such as a cellular phone, PDA, and the like) and be presented with a user specific web page and associated database information that is configured to facilitate user updating and storage of their personal information.

Alternately, the user may be provided with a client application or applications 264, as shown in FIG. 2 (also denoted herein as a “client” for purposes of brevity) that may be installed on the user's device 110. For example, the user may be provided with a download of the client application 264 from a host system 140 provided or affiliated web site. Alternately, the user may be supplied with the client application on a computer media such as a CD or DVD, a thumb drive, or via other media known or developed in the art. Once the user downloads or otherwise obtains the client application 264 and installs the client 264 on the user's device 110, the user may then access the host system 140 and associated host service to implement the functionality described herein. For example, in a typical embodiment, the client 264 is configured to allow the user to change their user information on the mobile device 110 and then transfer the information to the host system 140 for storage in a database 390 (as shown in FIG. 3) and/or for processing and distribution to the supplying user or other users. The client application 264 may also be configured to communicate directly with other clients 264 using technology such as SMS (Short Message Service) messages, MMS (Multimedia Message Service) messages, socket connection, or other client-to-client connection mechanisms. This allows a client application 264 on one device 110 to directly send updated information to other clients, including clients on other devices 110 or on other devices such as computers 120.

FIG. 2 illustrates additional details of a typical configuration of a portable device 110 with example device elements that may be used to implement embodiments of the present invention. As shown in FIG. 2, device 110 may include one or more processors (CPUs) 210, which are typically one or more specialized or dedicated portable device microprocessors or microcontrollers, an input/output device module 220 configured to allow users to input and output information and interact with the device 110, as well as transfer and receive data, one or more read only memory (ROM) devices 230 or equivalents to provide non-volatile storage of data and/or application or operating system programs, one or more display modules 250, such as an LCD or equivalent display device, as well as one or more memory spaces 260. Other modules, such as optional GPS module 225 for providing position or location information may also be included.

Memory space 260 may comprise DRAM, SRAM, FLASH, hard disk drives or other memory storage devices configured to store and access operating systems 262, application programs 264 and/or data 268. Data 268 may include information such as a user's contacts information in the form of contact records and associated data fields, images/photos, videos, music content or other types of content data. In particular, memory space 260 may include one or more client applications 264 (also denoted herein as an “IQZone client” or “client” for brevity) stored in the memory space 260 for execution on the CPU 210 to perform the various client-side functionality described herein, including displaying and storing user information, contacts, images, or other data or information, as well as interacting with host system 140.

FIG. 3 illustrates additional details of one example of a host system 140 with example device elements that may be used to implement embodiments of the present invention. As shown in FIG. 3, host system 140 may include one or more processors (CPUs) 310, an input/output device module 320 configured to allow users to input and output information and interact with the host system 140 as well as transfer and receive data, one or more read only memory (ROM) devices 330 or equivalents to provide non-volatile storage of data and/or programs, one or more display modules 350 such as a computer monitor or other display device, one more network connections 340 and associated network interfaces 342 configured to allow host system 140 to connect to other systems, servers and/or portable devices, including other elements of system 140 in embodiments where the servers or other components are distributed at other physical locations, as well as one or more memory spaces 360 and one or more databases 390. Database(s) 390 may be further divided or distributed as one or more sub-databases 390a-390n, with the sub-databases storing feature or function specific information associated with a particular feature or function. The various components shown in FIG. 3 may be incorporated in one or more physical servers 370 comprising part of host system 140. It is noted that the various components shown in FIG. 3, including database 390, are typically included as part of server(s) 370, however, they may be external to server(s) 370 in some embodiments. For example, in some embodiments database(s) 390 may be external to server(s) 370 and may comprise part of a separate database server system or networked database system.

Memory space 260 may comprise DRAM, SRAM, FLASH, hard disk drives or other memory storage devices configured to store operating systems, application programs and/or data, and memory space 260 may be shared with, distributed with or overlap with the memory storage capacity of database 390. In some embodiments memory space 260 may include database 390 or in some embodiments database 390 may include data 368 as shown in memory space 260.

Data stored in memory space 260 and/or database 390 may include information such as a user's contacts information, images/photos, videos, music content or other types of content. In particular, memory space 260 may include a host system application or applications 364 (also denoted as an IQZone host) stored in the memory space for execution on CPU 310 to perform the various host-side functionality described herein.

In some embodiments, portable device 110 may be configured to allow a user to send an MMS message, sometimes referred to as a picture message, to a service phone number associated with a host service, such as a service offered by IQZone Inc. at the web site www.iqzone.com. This phone number may be an international number, such as +16023695000 or a CSC (Common Short Code), which is a shorter number, such as 73425, which spells PDIAL. Ultimately, a variety of numbers may be made available in various countries to facilitate user communications between devices 110 and other devices 110 and/or host system 140.

A user can change the picture that is displayed for their caller ID on other user's devices in a number of ways. Many users will likely wish to use a picture from a social networking site 160, such as FaceBook® or MySpace®, or will use the client application 264 to change their picture. However, some phones include the capability of directly sending a picture message. For these phones, the host system 140 reads incoming picture messages and notes the phone number that the message originated from. The host system 140 then associates the received picture with the received phone number in the database 390. As the various devices that contain this contact synchronize, they will receive the new caller ID photo as described elsewhere herein. In this manner, users can update their caller ID photo from their mobile phone even if they have not installed the client application 264.

In another embodiment, portable device 110 may be configured to allow a user to send an SMS message, commonly called a text message, to either an international number or CSC, allowing a user to update their status message and other contact information.

In another embodiment, a user can update their information on a social networking site 150, such as FaceBook®. User information may be automatically updated from FaceBook® and other sources periodically as further described herein by accessing the social network site 160 from the host system 140, obtaining and reviewing information stored on the social network site, and then downloading the information to the host system 140 for storage in the database 390 and/or transferring information from the database 390 to the social networking site 160.

User Groups and Security

In typical embodiments, a user can update their caller ID photo, status message or other contact information and choose with whom to share this information through host system 140 via a host system application 364. In some embodiments a host service and associated host system 140, such as an IQZone service, may include a set of one or more built-in groups, such as groups based on Family, Friends, Friends of Friends, and All. A set of these built-in or predefined groups may be provided to users for the sake of convenience. Users are free to use these groups and/or users may also be allowed to create their own groups through a host system application 364. Group information may be stored in database(s) 390 and used by host system application(s) 364 to select various users to receive content. The users' contacts can then be specified as belonging to any, none, or all of these groups. In addition, a user may be able to specify different pictures, status messages, and contact information for each group. A user may also be able to specify different information and pictures, images or video for each group. For example, a user could create a “Dating” group or “Volleyball Team” group and specify different information and pictures for each of those groups. In order to facilitate group creation and access, a host services application 364 may be configured to store group information for each user in database 390 and then update this information based on additional information retrieved from the user's portable device 110, the Internet, or from a user's social networking account on a social networking site 160.

As an example, the host system 140 may allow a user to place his immediate family contacts in a “Family” group. The user can then specify that only the members of this group (i.e., family members identified by the user or the host system 140) receive a caller ID picture that is of a more personal or private nature. The groups are typically not known outside of the primary user, and serve as a tool for allowing a user to set permissions. This allows a user to have primary control over selection and creation of his or her groups, along with access by contacts/friends to information in those groups. In a typical embodiment, each group is granted access to certain host service features and may be blocked from others.

For example, one feature may be a location function based on GPS functionality. Many current cellular phones and other portable devices have built-in GPS functionality to provide coordinate information on the user's current location. The GPS coordinates of a first user (based on, for example, the location of the first user's device 110) can be obtained in the portable device 110 by client 264 and then transmitted to the host system 140 to be selectively shared with a group. For example, if a second user is a member of a group that has been given access to the first user's GPS coordinates, the second user may be provided with the first user's GPS coordinates and can see the first user's current location based on those coordinates. Users may also be able to store pictures in virtual photo-albums, which are stored on the host system 140. Groups may be granted access to see the photo-album, to change and add pictures to the photo album, or may be given no permission.

Updating of Information in a Host System Server Database

In typical embodiments, the host service and associated host system 140 receives updated information via all of the methods described above as well as from a variety of Internet sources. In order to facilitate this, an Internet services database associated with the host service (such as a sub-database 390a in host server system 140 as shown in FIG. 3) may be created, with the sub-database containing a list of Internet sources to be accessed by a host application 364 to obtain user information, along with a set of rules and specific programming source code for each source. In an exemplary embodiment, each Internet source/site has a specific c# code written for it so that the host system 140 knows how to access the various items of information and data available from that site. For example, the rules may include information such as specifying how often a source should be checked for new data, how to contact the source, how to correlate a contact with their corresponding information on the source, what information can be updated from that specific source, and the like. As a specific example, in one embodiment the host system servers 370 are configured so that FaceBook® has a specific time frame that each contact is checked by a host application 364 for new data and the picture and status information are updated. Another rule relates to saving of user credentials such as username and passwords. In the case of FaceBook information, the host system 140 needs only login once and is then assigned a ‘token’ that can be used going forward. This is essentially a more efficient way to access the account, without having to submit a username and password each time. In the case of MySpace, the host system needs to perform a login each time, and the rules and code are set accordingly.

Host System Server Transmitting Information to Clients

In order to facilitate contact and data synchronization, a client application 264 is typically provided to a mobile device 110 and then installed on the device using techniques such as are known or developed in the art. When the client 264 is installed on a device 110, the client performs a check of the device capabilities. The client 110 typically first checks to see how much memory is available and what the screen resolution is, and how many colors the device supports. It then attempts to create several pictures in various formats to see which formats are supported, after which the address book is accessed and information retrieved. Device and address information is then sent by client 264 to host system 140.

The transmitted information is received at the host system 140, which stores the capabilities and other data and information, in conjunction with a host application 364, in memory space 360 and/or database 390 for later use. For example, one of the device 110 capabilities that may be stored is whether the device supports push messaging. The client 264 may also tell the host system 140 which contact fields it supports. For instance, some devices have an anniversary field, and some do not. Devices that do not support the anniversary field will not be given anniversary data. The list of available fields varies from device to device, though some fields are common to many devices. For example, fields such as FIRSTNAME, LASTNAME, PHONENUMBER and EMAIL are common to many devices and are of the data type STRING, meaning any characters can be stored in the field. The Anniversary field is of type DATE and only valid dates can be stored in the field. Some devices support a PHOTO field of type BINARY, which allows us to store a picture or image in a binary format directly into the field. For example, images can be stored in standard binary formats such as jpg.

Additionally, the client 264 may specify picture sizes and formats it wants to receive from the host system 140, such as sized and formats based on the capabilities of the device 110 and/or based on other parameters such as memory capacity, download connection capacity or costs, or other parameters. The host system 140 receives this information from the client 264, and, in response, the host system formats the data specifically for each client based on the client's request and device 110 capabilities. The host system 140 may then transmit the customized data information to device 110 clients 264 in a number of ways, including those described further in the examples below.

A1. When the host system 140 receives new or updated information for a contact, it searches the database 390 and identifies all of the devices in the database that contain that contact information. The database 390 (or sub-database(s) 390a-n) may be configured to contain information about each device 110 and the device's associated user and contacts, and for those devices that support a particular content transfer method such as push messaging, a message is sent out to each one so they may receive an immediate update. The push message sent out may contain a token indicating that the client 264 should contact the host system 140 for an update. In response, the client 264 will then contact the host system 140 and do a normal or standard update, as is described in Section B1, below. Using this method allows updates with a minimum of push information being sent to the client 264.

Alternatively, in some embodiments the message may contain the updated information itself. In addition, for larger content sizes, the content may be divided and distributed in multiple messages. For example, if the information to be transmitted to the client 264 cannot reside in a single message, then multiple messages may be generated and sent by the host system 140. In this case, each message will contain the same message number, or other unique message identifier, along with a sequence number. The first message will also contain the total number of messages to receive for the sequence. Consequently, by using this approach it is not necessary for the client to receive the messages in order. The client will store the messages until they are all received and then put the messages back in sequence. The client 264 can then parse out all of the received data, reorganize the data into the correct sequence and format, and then update the contact and picture information on the device 110. If a message is missing or data is corrupt, the client 264 may contact the host system 140 and request the data be sent again. Depending on the particular client 264 configuration, the client will contact the host system 140 and associated host system servers by mechanisms known or developed in the art such as SMS or HTTP Post, or other methods known or developed in the art.

B1. In typical embodiments, the client 264 periodically contacts the host system 140 and requests updated information. The client 264 may also send updated contact information which will be synchronized with a contacts database, such as in database 390, or a sub-database or databases 390a-n, in the host system 140. The client 264 may contact the host system 140 and associated host system servers 370 using, but not limited to, an HTTP Post request, containing the request and updated client information. The host system 140 responds with the updated information, which is then read by the client 264 during the HTTP Post request.

C1. A user can install an application on their computer 120, typically a personal computer (PC) application configured to run in a desktop operating system such as Microsoft Windows®, Apple OSX®, Linux, or other desktop operating systems. This application will provide similar functionality to the client application 264 to facilitate synchronizing the contacts on the user's computer 120 with the host system 140 servers. A device 110 may also be connected to the computer 120 and then synchronized with the computer after it has been synchronized with the host system 140. Synchronization using this method has the added benefit of not using any device 110 air-time or incurring messaging costs.

Receiving Updated Information on the Device

After a user has installed the client application 264, they can receive updated information in a number of ways. Examples are further described below.

A2. When the host system 140 receives new or updated information for a contact, for those devices 110 that support push messaging, it sends out an immediate update. This was described previously herein in as an example in the Host System Server Transmitting Information to clients section.

B2. The user can manually specify synchronization from a menu on the device 110 provided by the client application 264, such a “main menu” or “options menu.” The client 264 will then immediately contact the host system 140 and request updated information.

C2. The client 264 will periodically poll the host system 140 and check for updates. If new or updated information is available, the host system 140 will send the new and/or updated information during these periodic checks.

Device Authentication

When a client application 264 has been installed on a portable device 110 (such as a cellular phone), the associated phone number cannot always be determined with 100% certainty. Host system 140 will typically require an authenticated phone number in order to allow the user to update his or her information from the portable device 110. Without an authenticated phone number, a user could spoof or impersonate other users and change their information in a host system 140 database, such as database 390 or sub-database(s) 390a-n, without authorization. Consequently, in typical embodiments, phone number authentication may be performed using a variety of methods, depending on the device 110 capabilities. These include, but are not limited to the following:

A3. If the client 264 can authoritatively read the phone number from associated device 110 and/or from a SIM (Subscriber Identity Module, which is a small card used in GSM phones to identify the user for billing and other services—SIM cards can also store information such as contacts so that if a user moves the card to another phone the contact information is available on the new phone.) then no further authentication is required. The host system 140 typically includes a database of devices 110 that may be stored in database 390 or a subdatabase 390x, which list which devices can authoritatively read the phone # from the device and only use this authentication method on those devices. The method used to access the phone number information varies from device to device.

If the phone number is successfully read, then the host system is contacted using HTTP Push and the client 264 tells the server to flag the device and phone number as authenticated.

B3. If the device 110 is capable of reading incoming SMS messages, then the associated client 264 prompts the user for their phone number and sends an SMS to itself. If it receives the SMS then it has verified that the phone number is correct and has been authenticated. The client 264 then contacts the host system 140 using HTTP Push and communicates the device and phone number as authenticated.

C3. The host system 140 sends a key to the device 110 client 264 during any HTTP call. The client then sends the key back to the host system via SMS and the number is authenticated.

D3. The host system 140 sends a PIN to the client 264 via SMS. The client prompts the user for the PIN and then sends it to the host system 140 via HTTP. If the host system receives the correct PIN then the number is authenticated.

E3. Upon initial installation, the host system 140 sends a message to the device 110 asking if the device has just installed the client 264. The user then replies with an SMS with Y or N. This is typically done via a standard SMS (Text message) using the Device's operating system.

F3. A unique client 264 is created with a hard-coded phone number and stored in host system 140. In this implementation, a unique one-time-use link is created on or in conjunction with host system 140, with the link pointing to the unique client 264. The link is sent to the user's device 110, with the user then selecting the one-time link and downloading and installing the unique client 264 from the server in host system 140 that is associated with the link.

Sending and Receiving Customizable Information Based on Criteria

As previously described, in typical embodiments users can send updated information out to other users in real or near-real time. They may also be provided with the ability to customize the specific information each contact receives. This custom information can be provided by logging on a web site on or associated with host system 140 with a computer, by logging on the web site with a cell phone, or by providing it in the client application 264 on the device 110. For example, each contact could be given a different personal photo or additional contact information. This can be based on many criteria, including, but not limited to, geography, area code, specific phone number, email address or name.

As one example, a user may be provided with an interface to host system 140 to select a set of rules for contact transfers. These rules may be assigned a hierarchy by the user as they may be able to override each other. For example, a user could create a rule to share picture #1 with anyone in area code 480, except for their spouses' phone number, which falls in area code 480, but that rule is overridden specifically for them, and they receive picture #2. All others receive picture #3. These rules can also be applied to sharing additional information such as additional phone numbers, addresses, birthdays, or any other personal information. A username can be shared, allowing the capability to allow calls and messages to them without having to share any private information such as phone number or email address. Information can also be shared by relationship. A user can share any of this information with all the friends of a certain contact. Or, they could choose to share some information with all friends of friends. The optional clickable linked banner advertising can also be setup using these hierarchical rules.

A user can also choose the video or picture to be displayed on the device 110 while the phone is ringing, a different picture or video to display during the call, and a different picture or video to display at call termination. A user may choose to display a video waving bye at call termination for instance. All of these pictures and videos may be individually customized and assigned based on the discussed hierarchical rules.

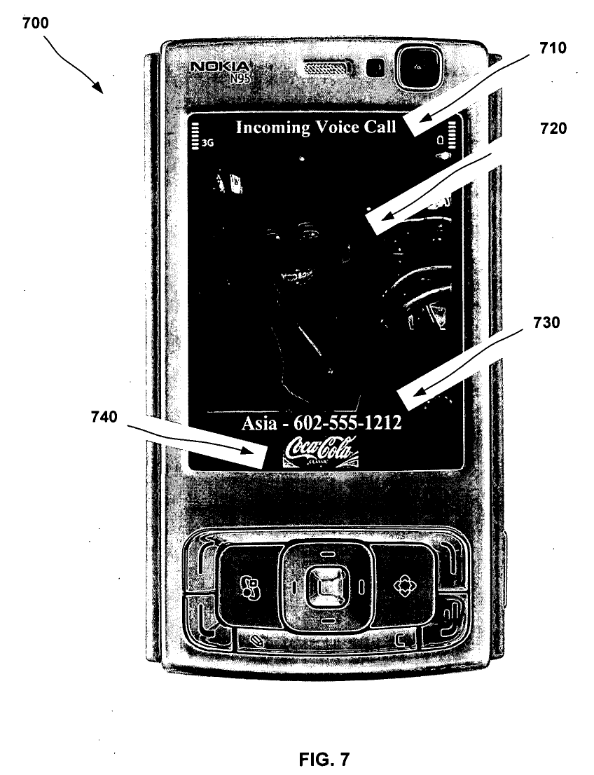

FIG. 7 illustrates one embodiment of a display screen 710 as may be implemented by a client application 264 in accordance with various aspects of the present invention. As shown in FIG. 7, an example device 110 (i.e., a cellular phone, in this case a Nokia N95), displays an embodiment of contact information on the phone display owned by a first user and based on information provided by or automatically configured from information provided to the host system 140 by a second user. In this example, the second user is a contact named “Asia,” as shown in the full screen display image 710. A field 710 indicates the device action associated with the contact - in this case an “incoming call” from Asia. Asia's phone number, name or other identifying information may be shown in field 730, which also includes her name. In addition, a banner ad 740 (for the Coca-Cola company), as further described herein in a successive section, may be displayed. Other information may also be included in the display screen 710 in various embodiments, and the configuration of these various elements may also be changed, with elements removed, additional elements added, and elements rearranged on the display.

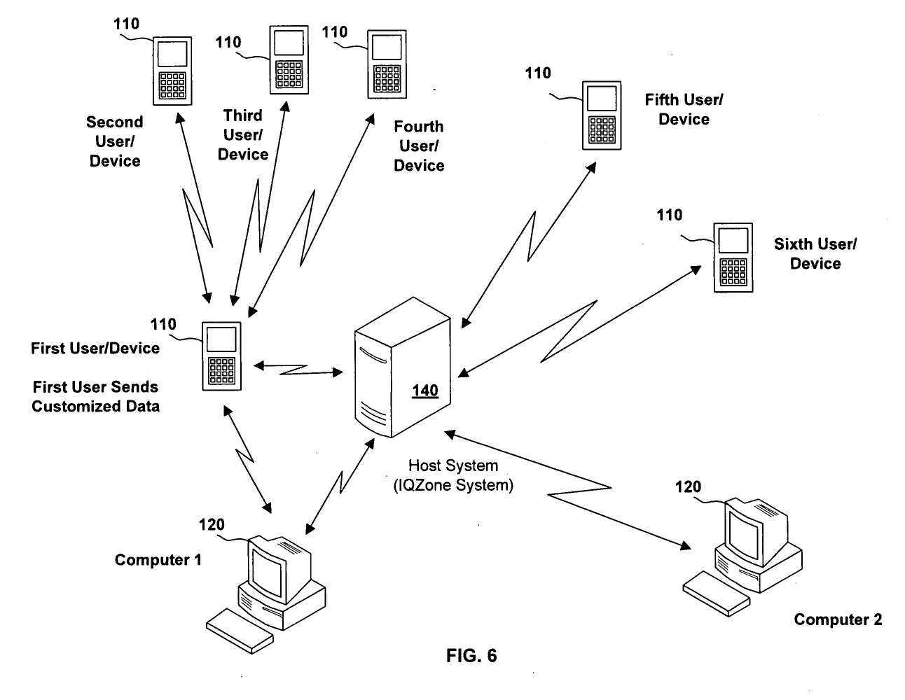

Attention is now directed to FIG. 6, which illustrates a system 600 on which may be implemented embodiments of the present invention. As shown in FIG. 6, system 600 may be configured to facilitate a first user and associated first device 110a sending customized information directly to other users with associated devices 110b-f. Customized information may be sent directly from device 110a to devices 110b through 110d in conjunction with clients 264 executing on devices 110a through 110d. In addition, the first user may send customized user information from device 110a to host system 140, where it may then be further processed by a host application 364 and then synchronized with other users and associated devices 110e and 110f.

It is noted that device 110b may receive different information than devices 110b through 110f based on selections and configuration information provided by the user associated with device 110a. It is further noted that it will typically be irrelevant whether the data is synchronized directly to other devices 110b-f or from devices 110b-f through synchronization with the host system 140. In addition, in some embodiments, computer users 120, such as desktop or notebook users, can login to a website provided on or in conjunction with the host system 140 and use their username or other credential to access, authenticate, edit and provide customized content to device 110a-f. Once authenticated, users can view the customized information meant for them.

Picture Speed Dialer

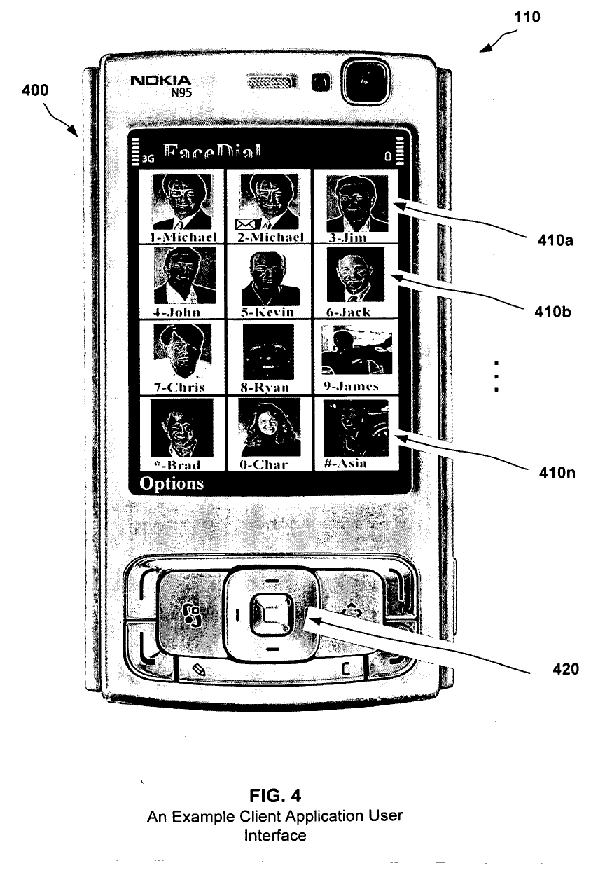

Attention is now directed to FIG. 4, which illustrates a user interface and display 400 provided by one embodiment of a client application 264. As shown in FIG. 4, a user's personal device 110, in this case a Nokia N95 cellular phone, provides a display including a plurality of contact pictures 410a-n, with each picture showing a user's face (typically in the form of a digital photo or other image) and associated name for the contact. Additional contacts can be displayed in the interface through multiple pages, scrolling, resizing of photos based on the number of contacts, or by other techniques known or developed in the art. Depending on the capabilities of the device 110, a user's name or picture may be selected for additional actions by scrolling to the user's face (where scrolling is implemented on the device 110), touching the name or image (where touchscreen functionality is provided on the device 110), or by other means of selection and actuation as are known or developed in the art.

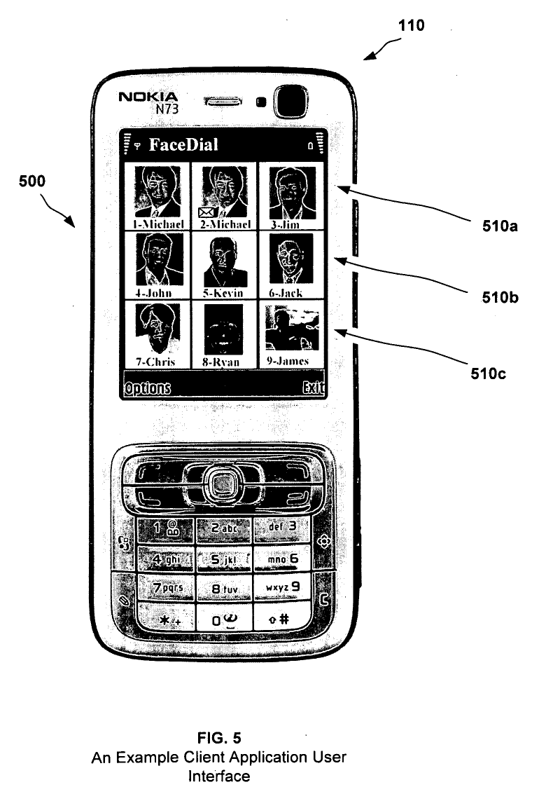

FIG. 5 illustrates another example of a user interface and display 500 provided by another embodiment of client application 264, in this case on a Nokia N73 cellular phone. FIG. 5 shows a different contact configuration based on the display capabilities of the device, with a 3×3 grid size of contacts and associated contact photos 510a-510c (the other 6 contact photos are not explicitly numbered in FIG. 3)

It is noted that the embodiments shown in FIG. 4 and FIG. 5 are examples and are not intended to be limiting. Other embodiments in keeping within the spirit and scope of the present invention are possible and fully contemplated herein. In various embodiments, features of the display may be configured or adjusted based on the device 110 capabilities and/or user preferences. For example, the client 264 may allow the user to customize the contact display grid configuration, adjusting the size, format, number of contacts, choice of displayed contacts (based on various criteria such as priority, popularity, frequency of contact, and the like), or other display characteristics.

The client 264 may also be configured to give the user the ability to use a speed dial mechanism in which the pictures are display on the device 110 in a grid representing the keys. For example, on some cellular phones this grid will be 3×4 to represent the keypad. On others, this grid may be 3×3 or another configuration that suits the cellular phone's screen display. Pressing the corresponding key will dial the corresponding user. For instance, pressing a 1 will initiate dialing of the user identified at grid coordinates (1, 1) of the display.

In addition to pictures, videos can likewise be selected for display for each contact. For example, a first user may choose to use the contact's (i.e. second user's) selection (i.e., a displayed picture, video, audio clip or other content selected for display by the second user). If the first user chooses to use the contact's selection, when that contact updates their information, the pictures, videos and/or other information will be automatically changed on the first user's device 110, either directly in conjunction with the client application 264 and/or through the host system 140. The first user may also be provided with an option to override the contact's selection. In this case, if the first user chooses to override the contact's selection, they may be notified when the contact changes their display information and may be provided with an option to view it, use it, and/or to prevent being asked in the future.

In an exemplary embodiment, when a contact calls the first user's device 110 (such as the first user's cellular phone), the client application 264 will display a full-screen caller ID screen with the picture or video for the contact. Some devices will not allow a client application 264 to display a custom caller ID screen. For those devices, a system caller ID picture or video may be stored in the address book in a compatible format, with the device's operating system 262 or other application programs then displaying the picture.

Additionally, the speed dial settings may be configurable to perform actions other than dial the contact via a telephony connection. For example, the contact speed dial setting may be set to contact the target in a variety of other ways, including, but not limited to, sending an MMS/picture message, sending an SMS/text message, recording and then sending an audio message, recording and then sending a video recording, live video chat, sending an email, or prompting for the contact option, which may be any of the previous options as well as others.

By way of example, it may be noted that in the user interfaces shown in FIG. 4 and FIG. 5, a number is associated with each contact. When the user presses the number 1 on the keypad, or otherwise selects “1,” the device 110 as controlled by client 264 will voice dial the contact named “Michael.” In addition, it may be noted that the contact labeled 2 is also “Michael,” and this contact includes an icon (i.e., a letter), which represents, in this example, messaging such as an SMS/text message. When a user presses the number 2 on the keypad or otherwise selects “2,” the device 110 as controlled by client 264 will initiate an SMS/text message rather than initiating a voice call. Other actions may be associated with the various numbers and contacts through use of icons, such as, for example, initiating voice calls, video calls, sending SMS (text message), sending MMS (picture message) and/or sending email.

In addition, in some embodiments contacts may also be selected by using the directional keypad 420 as shown in FIG. 4, in conjunction with the client 264, which will highlight the selected contact. The user can then move the highlight by pressing the directional keypad to navigate the contact display. The device 110 may then be configured to cause the speed dial to activate for the selected contact by pressing the directional pad 420. In some embodiments, multiple contact actions may be performed (such as, for example, simultaneously initiating voice and email messages, voice and text message, and the like).

Parental Monitoring and Blocking

In some embodiments, when contact information has been updated in host system 140, it may be scanned to see if the name, email, phone number, address, or other information matches any information for known sex-offenders or other undesirable contacts. This information may be collected and stored in database 390 or sub-databases 390a-n in host system 140, and then accessed to determine if one or more of these criteria, or other criteria identifying a contact as a potential sex-offender or other threat, is matched with the database information.

This function will typically be provided as an optional service that a parent or guardian may sign up for on the host service to monitor their children's mobile phone activities. During the signup process, the parent will be provided with a signup screen and other user interfaces from host system 140, such as via a web page, to specify the services associated with selected alerts as well as contact information for the parent to receive the alerts. This will typically be the parent's own mobile phone, but could also be via email or other contact mechanisms. In this manner, a parent can be notified of important events related to their child's mobile phone use.

In addition, contact pictures uploaded to host system 140 may be scanned using facial recognition algorithms, such as those known or developed in the art, to see if they match any known sex-offenders or other threats based on data or information stored in database(s) 390 in host system 140. In the event a match is found, the parents are immediately notified and the number is blocked on the handset for both incoming and outgoing calls and messages to that number. All messages received from that number are typically saved for the parent's review, but will not be shown on the children's device 110. Incoming calls may be immediately rejected by the client application 264 so the device doesn't ring if it receives a call from a flagged number. Parents may also be able to view a real-time blog of all phone activity, including messages, pictures and calls. This can be viewed on a web site on or associated with host system 140 and/or transmitted directly to the parent's own device 110.

In a typical embodiment, client 264 periodically updates activities of devices 110 to host system 140. This information may be provided in a web accessible format to allow parents to monitor the activity on a web site on or associated with host system 140 from a web browser, or directly on the parent's own device 110. The activity that may be monitored may include, but is not limited to, incoming calls, outgoing calls, missed calls, text messages sent, text messages received, picture messages sent, picture messages received, audio messages sent, audio messages received, the location of the device and the traveling speed of the device, as well as other related data or information.

Multimedia Message Service (MMS) Limits and Implementations of Large Data Transfers

In current systems for sending a picture message, also known as the Multimedia Message Service (MMS), limitations are imposed on the amount of data that can be sent. This limit is typically 100 kilobytes, or 300 kilobytes in some implementations. This data limit means that video frames sizes have to be very small and the video duration is typically limited to 15-20 seconds. If static pictures are sent, they are typically scaled down in size, sometimes well below the device's capabilities in order to facilitate transmission and/or minimize the transmitted data size.

In an exemplary embodiment, client application 264 in combination with device 110 and host system 140 allows users to send pictures and videos that are limited only by the capabilities of the mobile device. For instance, a Nokia N95 can take a picture that is 1600×1200 pixels. If a user were to send this picture via MMS, it would be scaled down to a fraction of this size before being sent. However, client application 264 can be configured to stream large amounts of data to a targeted device or host system 140. This may be done by opening a socket connection and then streaming chunks of the picture or video until everything has been sent. By streaming the data in chunks, very large file transmissions can be facilitated while avoiding limitations imposed by services such as MMS. If a user has a device 110 that can shoot high resolution stills, or record several minutes of video, then the large quantity of data contained in the image or video may be streamed from device 110 to host system 140 in the background, where the data is reformatted as needed for display on the targeted device 110.

For example, if a first user has a device 110 (i.e., a cellular phone) and wants to send a high resolution picture and a long video (i.e., media) to two friends (i.e., second and third users), the first user may select those friends from a menu on the client application 264, from a list of friends stored on the device, and then select the picture and/or video, and send this information to host system 140 and a host system application 364. This process is typically done in a transparent fashion from the first user's perspective, and will seem to be sent directly to their friends' phones.

Upon receipt, host system 140 will adjust the received media to the appropriate sizes and durations for the friends' phones. More specifically, the process may be done in the following fashion: 1) The host system 140 receives the pictures or videos from the first user, along with the name of a targeted second user (or multiple users); 2) The device capabilities of the other users are determined from a database 390 or sub-database 390x of system 140 containing device information; 3) The picture or video is resized to the appropriate dimensions for the target device(s) of the other users and stored in the correct data format for the target device(s). 4) The customized pictures/video are then sent to the target device(s) from the host system 140. The media is typically adjusted for each of the other users' devices 110 by host system 140, independently of any other devices 110 that are also receiving the media. So a device 110 with higher capabilities will receive a higher quality version of the media than a device with lower capabilities.

Clickable Linked Banner Advertising—Before Call, During Call and After Call

In some embodiments, a user acting as a sender may be provided with an option on their device 110, in conjunction with client application 264, to add a clickable banner advertisement to a photo or other content that he or she wishes to push out to other users. An example of such a banner is shown in FIG. 7 as banner 740. This can be done by logging in to a web site on or associated with the host system 140, or by selecting the banner from the client application 264 on the device 110. The client application 264 may present the user with a menu option and a selection of banner ads to choose from. Alternately , the banner ad(s) may be automatically selected for the user.

Once selected, the banner ad may be positioned by the user or may be automatically overlaid on the picture, typically at the bottom of the photo, but the ad may also be placed at other locations relative to the picture. In a typical implementation, host system 140 may include a selection of advertisements in database 390 or sub-database 390x that may be selected by the user on, for example, a selection menu on the user's device 110 and/or on a web page on or associated with the host system 140 and host service. The sender then chooses a desired banner ad from a collection of ads and also chooses one or more other users to push the photo or other content to.

After the content is sent, a portion of the ad revenue associated with the selected banner ad may then be shared with the sender. For example, the sender may be given an amount equivalent to one percent, five percent, ten percent or other fixed or variable percentages of ad revenue generated by sending the ad to other users. This revenue sharing may be automatically calculated and deposited into a user's account associated with the host service, the user's telecommunication carrier, or another user account. Alternately, the user may be required to select one or more banner advertisements for each set of content that is pushed to other users, without getting paid or otherwise reimbursed for sending the advertisement.

In typical embodiments, a user will be required to select one or more banner advertisements when pushing (or otherwise sending) content to others. If the sender does not want advertising associated with the content, he may be provided with an option to pay a fee to use the host service. As one example, a first user decides to associate a clickable banner ad with a picture and send it to 5 friends. The first user selects from a list of available ads, and, for purposes of explanation chooses a Coca-Cola ad. This ad is then associated by the host system with the first user's picture and sent to the other 5 users (friends). Upon receipt, those 5 friends now have updated information for the first user, including an updated profile picture and the banner ad now associated with the first user. Whenever the first user contacts other users, or vice versa, the banner ad is displayed and the first user receives a portion of the ad revenue generated.

It is noted that the advertisements need not be limited to clickable banner ads. Other types of ads, such as audio clips, videos, text, links or other content may also be provided. In some embodiments, a picture and a clickable ad banner may be displayed during a call from the first user to a second user (on the second user's device). Alternately or in addition, a status screen may be displayed at the end of the call with call details, such as call duration, along with an optional clickable banner ad at the bottom (or other periphery) of the called or calling device's display area.

As noted previously, FIG. 7 illustrates a sample display of an incoming call on a portable device 110, including a user selected advertisement 740. The same or similar types of advertisements may also be shown by the client application 264 during the call and/or at call termination. For video calls, and video messages, the banner ad may be displayed at the bottom or top of the screen or may also be optionally be displayed as an overlay on the video. In addition, audio clips or other types of advertising may also be rendered in conjunction with the incoming call (or other actions such as call termination).

Anonymous voice calling and messaging

In some embodiments anonymous voice calling and messaging may be facilitated by host system 140. For example, users may be assigned a username or other user ID by a host service associated with host system 140. For example, a first user may choose to share his or her username (for example, userid—“firstuser”) with a second user (userid—“seconduser”). The second user may then use the “firstuser” username to communicate with the first user. Users may do this on a website provided on or associated with host system 140 by selecting a control option which passes the two usernames to the host system 140 and associated servers 370. Users may also be able to access this functionality directly on their mobile devices 110 through client application 264.

The host system then uses the provided usernames to look up the two phone numbers of the respective first and second users and dial them both. This information may be stored in databaser 390 or a sub-database 390x. The host system 140 then bridges the call, allowing the first and second users to talk, in conjunction with the bridge, without ever having to share any personal information such as their names or phone numbers.

Similarly, users may also send text, video and audio messages to one another using the same username. Users may be provided with an option to block users at anytime, or remove access to their username entirely. They may also choose to only accept certain types of communications. For example, a user may elect to only be allowed to receive text message and pictures but not phone calls, or vice-versa. As one example of usage of this feature, a first user may choose to share their phone number and email with all of the contacts in their portable device 110′s address book, but then to decide to share only their username with the friends of their contacts. Those individuals (i.e., the friends of the first user's contacts) could then make anonymous contact with the first user using the first user's username, but would not have direct access to the first user's phone number or other personal information. This access via the first user's username could revoked at anytime by the first user by selection an appropriation revocation option through client application 264 and/or host system 140.

Friends of Friends

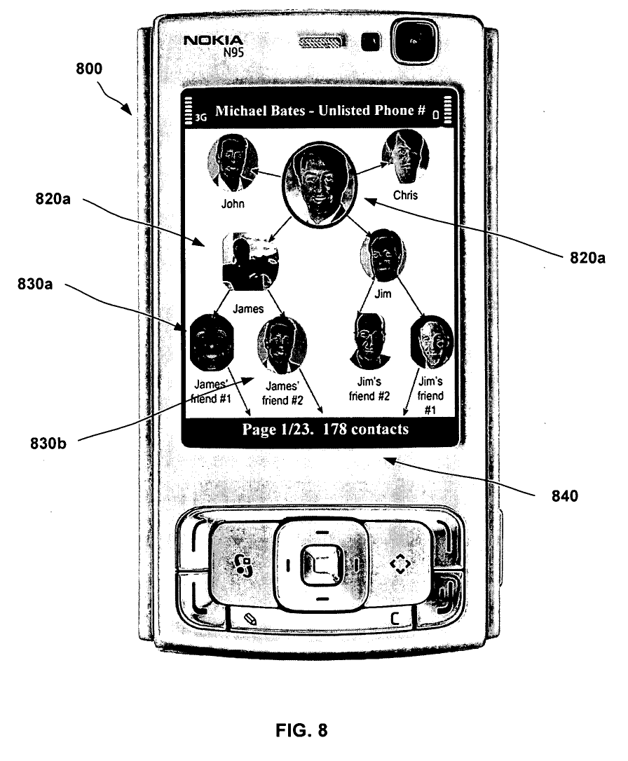

In some embodiments a feature denoted as “Friends of Friends” may be implemented. This feature allows a user to see which friends/contacts you share in common with other friends in a matrixed format, with contacts connected via lines or other connection mechanisms. This information can be displayed as a text representation or graphically, such as on a flow chart or interconnectivity chart showing the various relationships connected by lines or other connection symbols. This is illustrated in FIG. 8, which shows one embodiment of an interconnected contacts display with lines and arrowheads illustrating the contact connections. This information can be viewed on a user's portable device 110 as well as, in some embodiments, a website, such as a website provided on or in conjunction with host system 140 and/or on the user's cell phone 110 in conjunction with the client application 264.

In a typical embodiment, the connectivity chart may be several levels deep, showing friends of friends of friends, for instance. As an example, if user A shares a friend with one of their contacts, they can see a graphical or text representation showing this relationship. This information can go out to multiple levels of depth, showing friends of friends of friends, for instance. The chart can be configured so that it may be navigated by a user by selecting various relationships and traversing along the various relationship trees. Users may choose to share information with individuals on their list, or with an entire branch of friends, such as all the friends of their spouse as one example. They may also choose which information to share. They may wish only share their username, which will allow others to contact them with messages, pictures, videos and voice calls, but which will not divulge their private information, such as phone number or email address.

Turning again to FIG. 8, a sample embodiment of a graphical interface in as provided by a client application 264 in accordance with aspects of the present invention is shown. In an exemplary embodiment, the highlighted contact starts with self 810 (in this case user “Michael Bates”) and can be moved out to other contacts (friends) 820a-n. The highlighted contact may also show how many contacts 840 are available for display and/or in storage and may shows as many as will fit on the screen, which may be configured by the client application 264 and/or user preferences based on the device 110 capabilities. The interface may also allow the user to page left and right and/or up and down to get new screens of contacts, eventually scrolling through all of the highlighted person's primary contacts.

The interface may also allow the user to navigate the tree interface moving from friend to friend 820a-n down each branch and across two or more pages, while continuing to load data in the background from the host system 140 as needed. Each time a new contact is highlighted, the number of pages and number of contacts 840 may be changed to show that specific contact's other contacts. A local cache of some of the data may be kept on the device 110 and/or the host system 140 to speed the interface for subsequent scrolling. The device 110's directional pad may also be used to select other contacts. For example, as the highlight is moved, that contact becomes the new center point and the number of contacts available will change and the user can traverse the tree of friends. In this manner, the user can select available friends of friends and then scroll through all of their contacts that have chosen to share their information. In addition, searching functionality can be provided by client application 264 to allow for the narrowing or customized tailoring for a lost of contacts based on search criteria provided by the user. In the display shown, Michael is shown as being anonymous (i.e., having an unlisted phone number), however user Michael has allowed anonymous contact, as is desribed elsewhere herein.

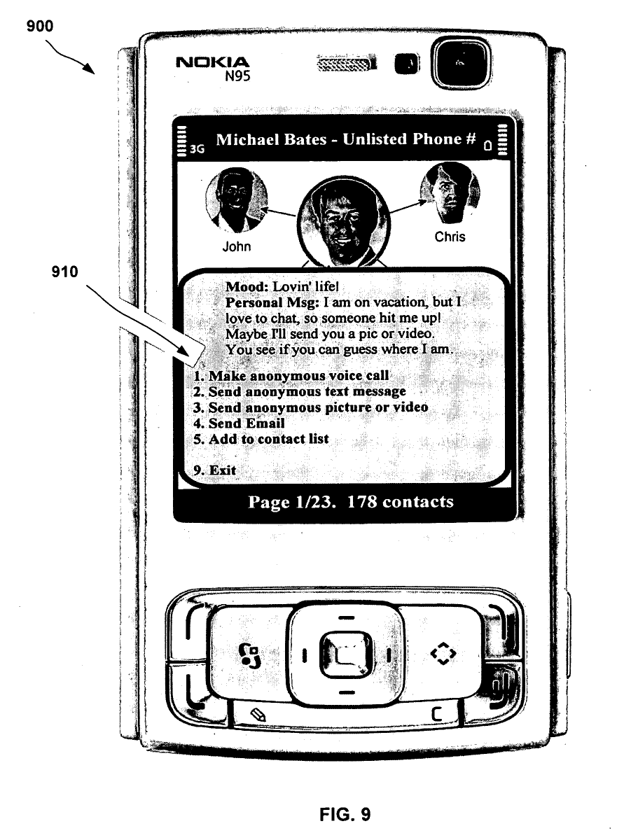

In various implementations, this user interface can also be used to facilitate contacting another user by pressing select. Pressing a select option will bring up a menu of options for the highlighted contact. For example, in FIG. 9, one embodiment of select option display 900 is shown. In this display, Michael's mood and personal message can be viewed and a menu of options 910 related to user Michael is displayed.

It is noted that in various embodiments the present invention may relate to processes such as are described or illustrated herein and/or in the related applications. These processed may be implemented on the host system 140 on one or more host system servers 370 by one or more host system application 364, as well as one or more portable devices 110 by one or more client applications 264. These processes are typically implemented in one or more modules comprising systems as described herein and/or in the related applications, and such modules may include computer software stored on a computer readable medium including instructions configured to be executed by one or more processors. It is further noted that, while the processes described and illustrated herein and/or in the related applications may include particular stages, it is apparent that other processes including fewer, more, or different stages than those described and shown are also within the spirit and scope of the present invention. Accordingly, the processes shown herein and in the related applications are provided for purposes of illustration, not limitation.

As noted, some embodiments of the present invention may include computer software and/or computer hardware/software combinations configured to implement one or more processes or functions associated with the present invention such as those described above and/or in the related applications. These embodiments may be in the form of modules implementing functionality in software and/or hardware software combinations. Embodiments may also take the form of a computer storage product with a computer-readable medium having computer code thereon for performing various computer-implemented operations, such as operations related to functionality as describe herein. The media and computer code may be those specially designed and constructed for the purposes of the present invention, or they may be of the kind well known and available to those having skill in the computer software arts, or they may be a combination of both.

Examples of computer-readable media within the spirit and scope of the present invention include, but are not limited to: magnetic media such as hard disks; optical media such as CD-ROMs, DVDs and holographic devices; magneto-optical media; and hardware devices that are specially configured to store and execute program code, such as programmable microcontrollers, application-specific integrated circuits (“ASICs”), programmable logic devices (“PLDs”) and ROM and RAM devices. Examples of computer code may include machine code, such as produced by a compiler, and files containing higher-level code that are executed by a computer using an interpreter. Computer code may be comprised of one or more modules executing a particular process or processes to provide useful results, and the modules may communicate with one another via means known in the art. For example, some embodiments of the invention may be implemented using assembly language, Java, C, C#, C++, or other programming languages and software development tools as are known in the art. Other embodiments of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

What is claimed is:

1. A host system for managing contact information, comprising:
a network interface for coupling the host system to the Internet and to one or more telephony communication networks;
a database; and
a server configured to:
communicate with a first portable device of a plurality of portable devices through the network interface to receive a set of contact information for a first user associated with the first portable device;
store, in the database, said contact information for said first user; and
transmit said contact information for said first user to a second portable device of said plurality of portable devices for synchronization with a set of contact data stored on said second portable device.

2. The system of claim 1 wherein said set of contact information is provided from the first portable device by a client application executing on said first portable device and wherein said client application is configured to:
retrieve said set of contact information from contact data stored on said first of said plurality of portable devices;
generate a synchronization file including the set of contact information; and
transmit the synchronization file to the host system for storage in the database.

3. The system of claim 1 wherein said set of contact information includes an image of said first user.

4. The system of claim 3 wherein said server is further configured to:
store, in the database, a set of device characteristics defining one or more display capabilities of said second of said plurality of devices;
resize, based on said device characteristics, said image of said first user to generate a resized image of said first user, wherein said resized image of said first user is generated to be compatible with said device characteristics; and
send said resized image of said first user to said second device.

5. The system of claim 1 wherein said server is further configured to:
retrieve, from a social networking site, a second set of contact information associated with said first user;
store, in the database, said second set of contact information; and
send said second set of contact information to said second device.

6. The system of claim 4 wherein said database includes a list of Internet sources for access by said host system.

7. The system of claim 6 wherein one or more Internet source specific program codes configured to define access to said Internet sources is stored in a memory of said server.

8. A host system for managing contact information, comprising:
a network interface for coupling the host system to the Internet and to one or more telephony communication networks;
a database; and
a server configured to:
communicate with a first portable device of a plurality of portable devices through the network interface to receive a set of contact information for a first user associated with the first portable device;
store, in the database, said contact information for said first user;
update a contact record for a contact of said first user stored in the database; and
transmit said updated contact record to said first device for synchronization with the corresponding contact information on the first device.

9. The system of claim 8 wherein said contact record is updated based on information provided by a second device associated with a second user in communication with said system.

10. The system of claim 8 wherein said contact record is updated based on information provided by a social networking site.

11. A method for managing contact information, comprising:
receiving at a host system, from a first portable device in communication with the host system, a set of contact information for a first user associated with the first portable device;
storing, in a database, said contact information for said first user; and
transmitting said contact information for said first user to a second portable device for synchronization with a set of contact data stored on said second portable device.

12. The method of claim 11 wherein said set of contact information is provided from the first portable device by a client application executing on said first portable device and wherein said client application is configured to:
retrieve said set of contact information from contact data stored on said first of said plurality of portable devices;
generate a synchronization file including the set of contact information; and
transmit the synchronization file to the host system for storage in the database.

13. The method of claim 11 wherein said set of contact information includes an image of said first user.

14. The method of claim 13 further comprising:
storing, in the database, a set of device characteristics defining one or more display capabilities of said second of said plurality of devices;
resizing, based on said device characteristics, said image of said first user to generate a resized image of said first user, wherein said resized image of said first user is generated to be compatible with said device characteristics; and
sending said resized image of said first user to said second device.

15. The method of claim 11 further comprising:
retrieving, from a social networking site, a second set of contact information associated with said first user;
storing, in the database, said second set of contact information; and
sending said second set of contact information to said second device.

16. The method of claim 11 wherein said database includes a list of Internet sources for access by said host system.

17. The method of claim 16 comprising storing one or more Internet source specific program codes configured to define access to said Internet sources in a memory of said host system.

18. The method of claim 11 further comprising:
updating said contact information stored in said database of said host system based on at least one updated contact data record associated with at least one of said contacts; and
sending said updated contact information to said portable device.

19. The method of claim 18 wherein said updated contact record associated with at least one of said contacts is provided to said host system from a social networking site.

20. The method of claim 18 wherein said updated contact record associated with at least one of said contacts is provided to said host system from said one of said contacts.

21. A method of facilitating contact synchronization between two or more portable devices, comprising:
retrieving a set of contact information stored on a first portable device;
generating a synchronization file including the set of contact information; and
transmitting the synchronization file to a second portable device, wherein the synchronization information is used by a client application on the second device to update a contact record on the second device.

22. The method of claim 21 wherein said retrieving a set of contact information comprises:
accessing, from a client application, an address book stored on said portable device;
iterating through a plurality of contact information contained in a plurality of contact fields in said address book; and
generating a data record including one or more data items for each of said iterated contacts.

23. A method of facilitating contact backup with a portable device, comprising:
retrieving a set of contact information stored on said portable device;
generating a synchronization file including the set of contact information; and
transmitting the synchronization file to a host system, wherein the contact information is stored in a database of said host system.

24. The method of claim 23 wherein said retrieving a set of contact information comprises:
accessing, from a client application, an address book stored on said portable device;
iterating through a plurality of contact information contained in a plurality of contact fields in said address book; and
generating a data record including one or more data items for each of said iterated contacts.

25. A method for providing contact location information, comprising:
receiving from a portable device at a host system location information for a first user;
selecting a second device associated with a second user to receive said location information; and
sending said location information from said host system to said second device.

26. The method of claim 25 wherein said location information is provided by a GPS module in said portable device.

27. The method of claim 25 wherein said selecting a second device comprises selecting, responsive to membership in one or more location enabled groups selected by said first user, said second user.

28. A method for presenting contact information on a portable device, comprising:
receiving, from a host system, a contact record for a first contact of a plurality of contacts associated with a user of the portable device;
storing said contact record in a memory of said portable device; and
displaying one or more items of data comprising said contact record on a display of said portable device in response to a first device action.

29. The method of claim 28 wherein said one or more items of data includes an image of said first contact, and said image is rendered on said display of said portable device in response to said first device action.

30. The method of claim 29 wherein said first device action is an incoming call.

31. The method of claim 29 wherein said first device action is a call termination.

32. The method of claim 28 wherein said contact record includes a contact name, a contact phone number, or a contact name and contact phone number.

33. The method of claim 28 wherein one or more banner ads is displayed on said portable device.

34. The method of claim 33 wherein said one or more banner ads are selected by said first contact.

35. A method for presenting contact information on a portable device comprising:
retrieving, from a memory in said portable device, ones of a plurality of images associated with a corresponding plurality of contacts;
displaying, on a grid presented on a display of said portable device, said plurality of images;
receiving, response to a user actuation, a device input associated with one of said plurality of images; and
initiating, responsive to said receiving, a function on said portable device.

36. The method of claim 35 wherein said plurality of images comprise images of said plurality of contacts.

37. The method of claim 35 wherein said device input comprises a user selection of one of said plurality of images on a touchscreen of said portable device.

38. The method of claim 35 wherein said function on said portable device is initiation of a communication with one of said contacts.

39. The method of claim 38 wherein said communication is a voice call.

40. The method of claim 38 wherein said communication is an email or text message.

41. A method of screening contacts on a portable device, comprising:
receiving, at a host system, incoming call information from a portable device associated with a first user;
comparing said incoming contact information to ones of a plurality of records defining potentially threatening callers associated with said call information stored in a database of said host system; and
blocking, responsive to said comparing, connection of said incoming call to said portable device.

42. The method of claim 41 wherein said potentially threatening callers comprise identified sex offenders.

43. The method of claim 41 further comprising sending a notification, from said host system, to a second device associated with a second user affiliated with said first user.

44. The method of claim 43 where said first user is a minor and said second user is a parent or guardian of said minor.

45. A method for facilitating large file transfers between two or more portable devices, comprising:
receiving, from a first portable device, a request to send a file to a second user, wherein said request is responsive to a limitation in file transfer capabilities associated with a telecommunication service provided to said first device;
initiating, responsive to said request, a data stream with said first device, wherein said data stream comprises said file;
storing, in a memory, said file; and
initiating, with a second device, a second data stream, wherein said second data stream comprises said file.

46. A method of providing contact information between portable devices, comprising:
receiving, from a first portable device associated with a first user, a request to send contact information to a second user, wherein said second user is associated with a second portable device;
providing an interface to said first user, said interface including one or more options for selection of ones of a plurality of banner ads;
receiving, from said first user, a selection of one or more of said plurality of banner ads;
selecting an image associated with the first user; and
transmitting the image and the one or more selected banner ad to the second device.

47. The method of claim 46 wherein the image associated with the first user is a facial image of the first user.

48. The method of claim 46 wherein the banner ad is selected automatically without input from the first user.

49. A method of providing anonymous communications, comprising:
receiving at a host system, from a first user, a request to communicate with a second user based on a username of said second user;
determining, based on a first username associated with the first user and the second username, contact information for said first user and said second user; and
providing a bridged connection between said first user and said second user.

50. The method of claim 49 wherein said contact information comprises phone numbers for said first user and said second user.

51. The method of claim 49 wherein said contact information comprises email addresses for said first user and said second user.

52. The method of claim 49 wherein said bridged connection comprises a bridged voice connection between said first user and said second user.

53. The method of claim 49 wherein said bridged connection comprises a bridged email connection between said first user and said second user.

54. The method of claim 49 wherein said bridged connection comprises a bridged SMS or MMS connection between said first user and said second user.

55. A method for displaying contact information on a portable device, comprising:
storing, in a memory of said portable device, contact information for a plurality of contacts associated with a first user of the portable device;
formatting said contact information for said plurality of contacts in a matrixed configuration; and
displaying said matrixed configuration on a display of said portable device, wherein said contacts are connected in said matrix based on a contact relationship with said first user.

56. The method of claim 55 wherein said contacts are displayed in said matrixed configuration using lines or arrows to show the contact relationship with said first user.

57. The method of claim 55 wherein said display is configured to be moved or paged by the first user in response to user actuation of a device input.

58. The method of claim 55 wherein said moving or paging comprises scrolling or paging the contact display in response to a user actuation of the device to show additional contacts not presented on the display.
